(19) United States
(12) Patent Application Publication
(10) Pub. No.: US 2022/0234777 A1
(43) Pub. Date: Jul. 28, 2022

(54) Garbage Bag Retention Device

(71) Applicant: Tanya Thistle, Fort McMurray (CA)

(72) Inventor: Tanya Thistle, Fort McMurray (CA)

(21) Appl. No.: 17/530,943

(22) Filed: Nov. 19, 2021

Related U.S. Application Data
(60) Provisional application No. 63/142,949, filed on Jan. 28, 2021.

(51) Int. Cl. B65B 67/12; B65F 1/06

(52) U.S. Cl. CPC B65B 67/1233; B65F 1/06

(57) ABSTRACT

The present invention relates to a garbage bag retention device. The body of the invention has an outer portion, a rounded top portion, an inner wall and a tab. The tab on inner wall extends outwards away from the inner wall. The tab has a plurality of semi-rigid slits disposed in a radial fashion around a center point opening. A trash bag can be placed through and trapped within the slits such that it is secured and held in position in the can. The bottom surface of the outer clip portion contacts the outside surface of a sidewall of a garbage can and the top portion of the clip further rests atop the top edge of the garbage can.

### CROSS-REFERENCE TO RELATED APPLICATION

The present application claims priority to, and the benefit of, U.S. Provisional Application No. 63/142,949, which was filed on Jan. 28, 2021, and is incorporated herein by reference in its entirety.

### FIELD OF THE INVENTION

The present invention relates generally to the field of trash receptacles, garbage cans, waste baskets and other containers securing devices. More specifically, the present invention relates to a garbage bag retention device comprised of a body having an outer clip portion, a rounded top portion, an inner wall and a tab. The inner wall includes a tab that extends outwards and away from the inner wall. The tab may be oriented at a plurality of angles ranging from between 0 to about 180 degrees in relation to the vertical inner wall, and has a plurality of semi-rigid slits disposed in a radial fashion around a center point or center opening of the receptacle, with about 10 to 45 degrees being preferred. A trash bag can further be placed through the slits by pushing the bag through the front-most slit. The slit, due to its flexibility of the material from which it is made, then returns to its original position and traps the bag within the tab, such that it is secured and held in position in order that the garbage bag is appropriately positioned within the can or receptacle. The bottom surface of the outer clip portion preferably contacts the outside surface of a side or other retaining wall of a garbage can or waste receptacle. The top portion further rests on top of the top edge of the garbage can or waste receptacle, such that the bottom surface of the top portion of the clip may or may not contact the top edge of the garbage can or waste receptacle. Furthermore, the bottom surface of the inner wall of the clip contacts the inside surface of the can. In this manner, the device can universally attach to the sidewall of any garbage can or waste receptacle. Accordingly, the present disclosure makes specific reference thereto. Nonetheless, it is to be appreciated that aspects of the present invention are also equally applicable to other like applications, devices and methods of manufacture.

### BACKGROUND

Most individuals place a plastic garbage, trash or other bag, or sack within a trash can, waste receptacle or other containers for holding garbage they use in their home, place of business or other setting where cans or receptacles may be available for collecting trash such as public areas. However, garbage bags or sacks are typically only secured around a garbage can by stretching the top perimeter of the garbage bag or sack around the top opening of the garbage can or waste receptacle. Although this procedure may secure the garbage bag or sack in a fixed position within the can to some degree, as the bag is filled with heavy garbage, it may become weighed down, such that the bag slips from around the edges of the garbage can and falls to the bottom of the interior of the can. This is undesirable and unsanitary, as the user must then reach into the garbage can each time the bag falls within the can and replace the bag around the top of the can. In addition, if the user is not aware the bag or sack has fallen, trash may be thrown in the can and may miss the bag or sack, thereby soiling the interior or the can.

Therefore, there exists a long-felt need in the art for an invention that prevents a garbage bag from falling into a garbage can or waste receptacle as the bag or sack is filled with garbage or trash. There also exists a long-felt need in the art for a garbage bag retention device which can be universally configured and attached to any garbage can or waste receptacle while preventing a garbage bag or trash sack from falling into a garbage can or waste receptacle as the bag or sack is filled with garbage or trash. Further, there exists a long-felt need in the art for a garbage bag retention device that is inexpensive to manufacture and easy to install.

The subject matter disclosed and claimed herein, in one embodiment thereof, comprises a garbage bag retention device. The device has a body that includes an outer clip portion, a rounded top portion, an inner wall and a tab which extends outwardly from the inner wall. The inner wall has a tab that extends outwards away from the inner wall to hold the bag or sack. The tab may have a deformable area with a plurality of slits oriented at a plurality of angles between 0-180 degrees in relation to the vertical inner wall, and has a plurality of deformable semi-rigid slits disposed in a radial fashion extending outward from around a center point and a central opening. A portion of the trash bag or sack can further be placed through the slits by pushing a part of the bag through the center and front-most slit. Once a portion of the bag is inserted through the hole and tabs, the slit then returns to its original position and traps the portion of the bag within the tab, such that it is secured and held in position. The bottom surface of the outer clip portion preferably contacts the outside surface of a sidewall of a garbage can or waste receptacle. The top portion of the invention further rests atop the top edge of the garbage can or waste receptacle, wherein the bottom surface of the top portion may or may not contact the top edge. Furthermore, the bottom surface of the inner wall contacts the inside surface of the can. In this manner, the device has a universally adaptable attachment to the sidewall of virtually any garbage can or waste receptacle.

In this manner, the garbage bag retention device of the present invention accomplishes all of the forgoing objectives and provides a device that prevents a garbage bag or trash sack from falling into a garbage can as the bag is filled with garbage. The bag or sack is secured to the sidewall of the can or other container. The device can further be universally attached to any garbage can while preventing a garbage bag from falling into a garbage can or slipping away from the wall as the bag is filled with garbage or trash. In this manner, the garbage bag retention device overcomes the deficiencies of existing garbage bags and methods of securing garbage bags within trash cans known in the art.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a garbage bag retention device. The device has a body with an outer clip portion, a rounded top portion, an inner wall extending down from the top portion and a tab extending out from the inner wall. The invention is manufactured from a flexible material and the outer clip or wall portion and the inner wall clip clamp are biased together, so as to hold the clip to the sidewall of the trash container. The body has a curved outer clip portion and a rounded top portion that connects the outer clip to the inner wall. In the preferred embodiment, the body has a molded, one-piece construction where all portions are connected together and not separable from the other components. The bottom surface of the outer clip portion preferably contacts the outside surface of a sidewall of a garbage can. The top portion further rests atop the top edge of the garbage can or trash receptacle, and the bottom surface of the top portion may or may not contact the top edge of the can or trash container. Furthermore, the bottom surface of the inner wall contacts the inside surface of the can.

The device can further universally attach to any garbage can or trash receptacle of virtually any size known in the art. To secure the invention to a sidewall of a can, the clip portion is pushed away from the bottom surface of the inner wall to allow the device to be positioned around the sidewall. The outer clip portion is on the outside surface of the sidewall and the inner wall is on the inside surface of the sidewall. Once in the appropriate position, the clip portion can be released (e.g., the user can remove their hand from the device) such that the clip portion and inner wall contact and compress against the sidewall of a can to provide compressive forces against the sidewall. In this manner, the device is then secured to the sidewall of the can. To aid in securing the device to the sidewall, the bottom surfaces of the outer clip portion and the inner wall may further include at least one fastener such as, but not limited to, a peelable adhesive layer, a hook and loop fastening assembly, at least one magnet, at least one suction cup, etc.

The inner wall includes a tab that extends outwardly away from the inner wall. The tab may be oriented at a plurality of angles between 0 to 180 degrees from vertical in relation to the vertical inner wall and has a plurality of semi-rigid or flexible slits disposed in a radial fashion around a center point or center opening with about 10 to 45 degrees being preferred. A garbage bag or trash sack can further be placed through the slits by pushing the bag through the center and one of the slits such as the front-most slit, and the slit then returns to its original position and traps the bag or sack within the tab such that it is secured. The bag can then be draped over the inner wall and placed inside a garbage can or waste receptacle. Because of the shape of the body and the manner in which the various portions of the body contact the sidewall of the can or container, the bag or sack cannot slip into the interior portion of the garbage can or waste receptacle, even when full of heavy garbage or trash. For additional support, the bag or sack can still be draped over the top edge of the can, as would a normal trash bag or refuse sack.

Accordingly, the garbage bag retention device of the present invention is particularly advantageous as it prevents a garbage bag or sack from falling into a garbage can or away from the sides walls as the bag is filled with garbage. The device can further be universally-attached to virtually any garbage can while preventing a garbage bag or trash sack from falling into a garbage can or waste receptacle as the bag or sack is filled with garbage. In this manner, the garbage bag or trash sack retention device overcomes the deficiencies of existing garbage bags and methods of securing garbage bags within trash cans known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates multiple perspective views of one potential embodiment of a garbage bag retention device of the present invention in accordance with the disclosed architecture;

FIG. 2 illustrates an enhanced side view of one potential embodiment of a garbage bag retention device of the present invention in accordance with the disclosed architecture;

FIG. 3 illustrates a side view of one potential embodiment of a garbage bag retention device of the present invention in accordance with the disclosed architecture;

FIG. 4 illustrates a top view of one potential embodiment of a garbage bag retention device of the present invention in accordance with the disclosed architecture;

FIG. 5 illustrates a perspective view of another potential embodiment of a garbage bag retention device of the present invention in accordance with the disclosed structure; and

FIG. 6 illustrates a perspective view of another potential embodiment of a garbage bag retention device of the present invention in accordance with the disclosed structure.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that prevents garbage or trash bags from falling into a garbage can or other waste receptacle as the bag or sack is filled with garbage or trash. There also exists a long-felt need in the art for a garbage bag retention device which can be conveniently attached to any garbage or trash can while preventing a garbage or trash bag from falling into a garbage can or waste receptacle as the bag or sack is filled with garbage or trash. Further, there exists a long-felt need in the art for a garbage bag retention device that is inexpensive to manufacture and easy to use.

The present invention, in one exemplary embodiment, is comprised of a garbage bag retention device. The invention is comprised of a body with an outer clip portion, a rounded top portion, an inner wall and a tab extending out from the inner wall portion. The body has a curved outer clip portion and a rounded top portion that connects the outer clip to an inner wall of the retention device. In the preferred embodiment, the body is a molded, one-piece construction and all portions are inseparably connected to one another. The bottom surface of the outer clip portion preferably contacts the outside surface of a sidewall of a garbage can or waste receptacle. The top portion further rests atop the top edge of the garbage can, and the bottom surface of the top portion may or may not contact the top edge of the garbage can or waste receptacle. Furthermore, the bottom surface of the inner wall contacts the inside surface of the can.

The shape of the invention allows it to attach to virtually any garbage can or waste receptacle of any size known in the art. To secure the device to a sidewall of a can or other trash container, the clip portion is pushed away from the bottom surface of the inner wall to allow the invention to be positioned around the sidewall. The outer clip portion is positioned on the outside surface of the sidewall, and the inner wall is in contact with the inside surface of the sidewall. Once in the appropriate position, the clip portion can be released (e.g., the user can remove his or her hand from the device) such that the clip portion and inner wall contact the sidewall of a can to provide compressive forces against the sidewall. As a result, the invention is then secured to the sidewall of the can. To aid in securing the invention to the sidewall, the bottom surfaces of the outer clip portion and the inner wall may further have at least one fastener such as, but not limited to, a peelable adhesive layer, a hook and loop fastening assembly, at least one magnet, at least one suction cup or a combination thereof to secure the clip to the side of the can and to prevent the clip from sliding out of position.

The inner wall has a tab that extends outwards away from the inner wall, and the tab may be oriented at a plurality of angles ranging between 0 to about 180 degrees in relation to the vertical inner wall with about 10 to 45 degrees being preferred. The tab has a plurality of flexible, semi-rigid slits disposed in a radial fashion around a center point or center opening. A garbage bag or trash sack can further be placed through the slits by pushing the bag through the opening and at least one of the slits such as the front-most slit which deforms to receive the bag or sack and then the slit returns to its original position and traps the bag or sack within the tab such that it is secured or held in position. The bag can then be draped over the inner wall and placed inside a garbage can or other waste receptacle. Due to the shape of the body and the manner in which the various portions of the body contact the sidewall of the can or trash container (e.g., the leverage angles created), the bag or sack cannot slip into the interior portion of the garbage can or waste receptacle, even when full of heavy garbage or trash. For additional support, the bag can still be draped over the top edge of the can, as would a normal trash bag in addition to being held by the clip.

Accordingly, the garbage bag retention device of the present invention is particularly advantageous as it prevents a garbage or trash bag or sack from falling into a garbage can or waste receptacle or separating away from the side of the can or container as the bag is filled with garbage or trash. The device can further be attached to virtually any garbage can or waste receptacle, while preventing a garbage or trash bag from falling into a garbage can or separating away from the side edge as the bag or sack is filled with garbage or trash. In this manner, the garbage bag retention device overcomes the deficiencies of existing ways of holding garbage bags in a garbage can or waste receptacle and methods of securing garbage or trash bags within trash cans known in the art.

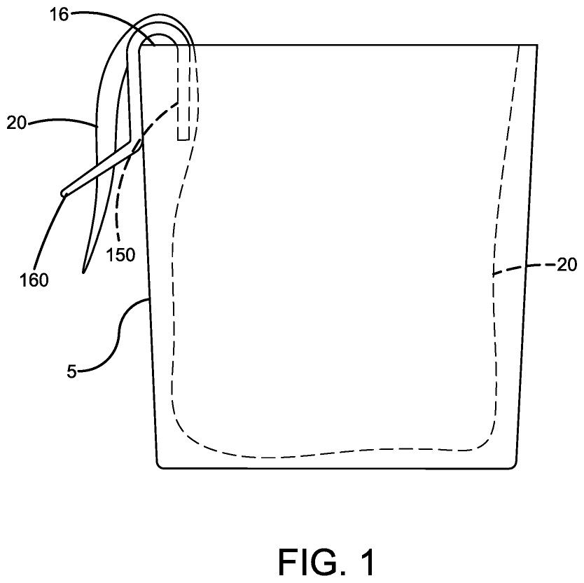

Referring initially to the drawings, FIG. 1 illustrates multiple perspective views of one potential embodiment of a garbage bag retention device 100 of the present invention in accordance with the disclosed architecture. The device 100 has a body 110 with an outer clip portion 130, a rounded top portion 140 creating a bulbous portion to fit over the rim of a garbage can or waste receptacle, an inner wall 150 and a tab 160. In differing embodiments, the entirety and/or select portions of the body 110 may be manufactured from a durable metal or a rigid and/or semi-flexible plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic or combinations thereof. In differing embodiments, the body 110 may be any color known and may have a plurality of indicia 170 such as but not limited to: patterns, logos, emblems, images, symbols, designs, letters, words, characters, animals, advertisements, brands or combinations thereof.

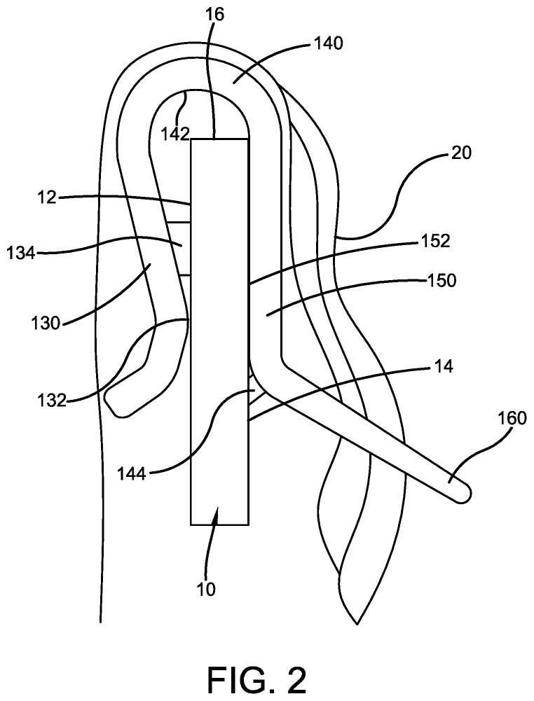

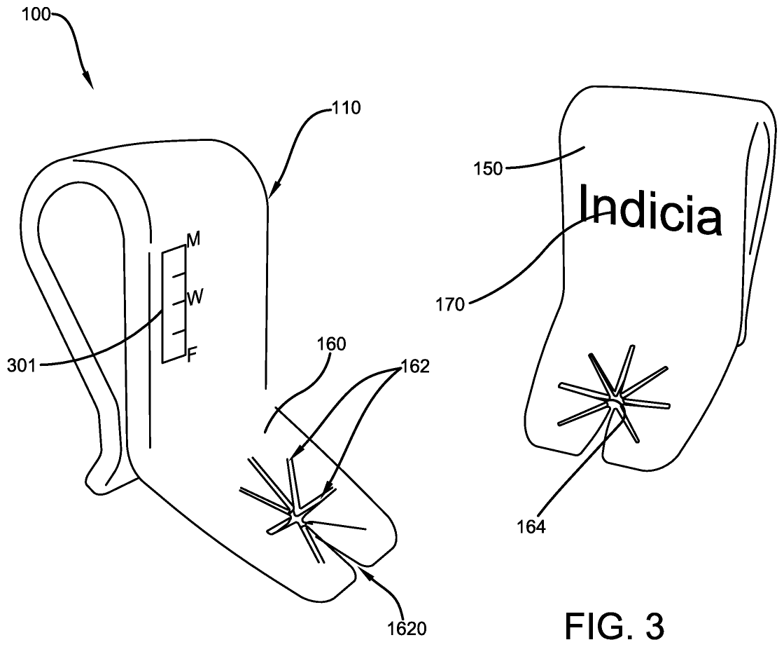

FIG. 2 illustrates an enhanced side view of one potential embodiment of a garbage or trash bag retention device 100 of the present invention in accordance with the disclosed architecture. The body 110 has a curved outer clip portion 130 and an inner wall 150. The clip portion 130 and the inner wall 150 are connected to one another by a rounded top portion 140 having a bulbous region to fit over the rim 16 of a garbage can or waste receptacle. It should be noted that in the preferred embodiment, the body 110 is manufactured in a molded, one-piece construction such that all portions 130, 140, 150 are connected in a one-piece construction. In differing embodiments, the top portion 140 and/or outer clip portion 130 may also be flat instead of curved or bulbous. The bottom surface 132 of the outer clip portion 130 preferably contacts the outside surface 12 of a sidewall 10 of a garbage can or waste receptacle 5. The top portion 140 further rests atop the top edge 16 of the garbage can 5. The bottom surface 142 of the top portion 140 may or may not contact the top edge 16 of the can or trash receptacle. The bottom surface 152 of the inner wall 150 further contacts the inside surface 14 of the can 5. However, it should be appreciated that the invention 100 can be placed on a garbage can 5 in the opposite orientation of what is shown in FIG. 2 (as seen in FIG. 3).

In this manner, the device 100 can attach to virtually any garbage can 5 of any size currently available to consumers. To secure the invention 100 to a sidewall 10 of a can 5, the clip portion 130 can be pushed away from the bottom surface 152 of the inner wall 150 by the hand of the user, to allow the invention 100 to be positioned around a sidewall 10 of a can 5. The outer clip portion 130 is on the outside surface 12 of the sidewall 10 and the inner wall 150 is on the inside surface 14 of the sidewall 10, as noted above. Once in the appropriate position, the clip portion 130 can be released (e.g., the user can remove their hand from the device 100) such that the clip portion 130 and inner wall 150 “snap back” and contact the sidewall 10 of a can or receptacle 5 to provide compressive forces against the sidewall 10 to secure the device 100 to the can 5. To aid in securing the device 100 to the can or container 5, either or both bottom surfaces 132, 142 may further have at least one fastener 134, 144 such as, but not limited to, a peelable adhesive layer, a hook and loop fastening assembly, at least one magnet, at least one suction cup or combinations thereof.

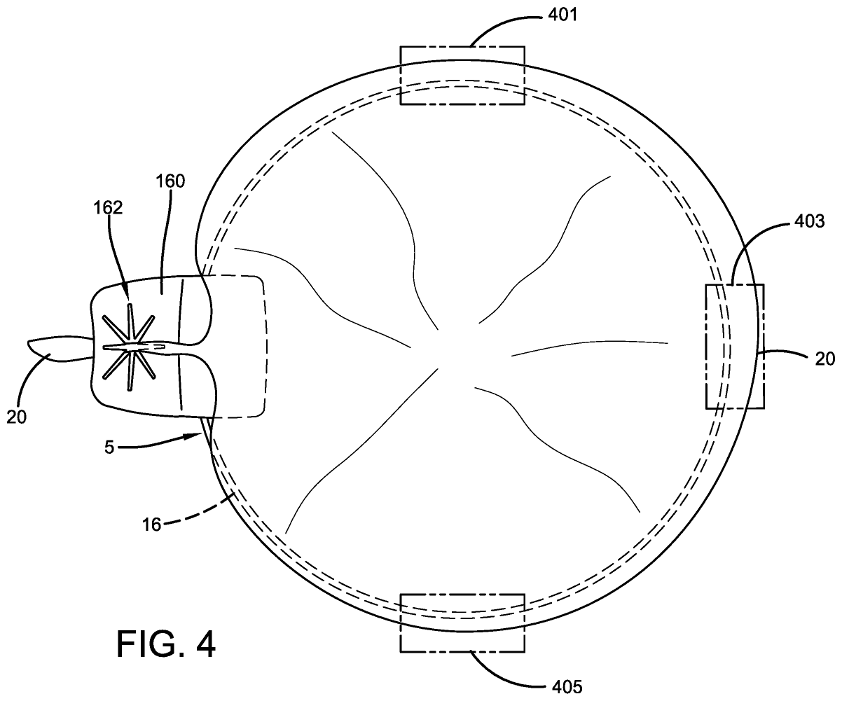

As also best seen in FIG. 1., the inner wall 150 has a tab 160 that extends outwards away from the inner wall 150 of the clip. In differing embodiments, the tab 160 may be oriented at a plurality of angles ranging between 0 and about 180 degrees in relation to the vertical inner wall 150 with about 10 to 45 degrees being preferred. The tab 160 includes a plurality of flexible, semi-rigid or rigid slits 162, disposed in a radial fashion around a center point or center opening 164. A trash bag or sack 20 can further be placed through the slits 162 by pushing the bag 20 through the center and locking the back in one of the slits such as the front-most slit 1620. Once placed within the center opening 164, the slit 162 returns to its original position and traps or holds the bag 20 within the tab 160 such that it is secured and held in position. As seen in FIG. 3, the bag or sack 20 can then be draped over the inner wall 150 and placed inside a garbage can or waste receptacle 5. FIG. 3 also shows a chart or reminder 301 for indicating the date of the week that the garbage or trash may be collected. Due to the shape of the body 110 and the manner in which the various portions of the body 110 contact the sidewall 10 of the can 5 (in addition to the slits 162) and create leverage angles, the bag or sack 20 cannot slip into the interior portion of the garbage can 5 or separate from the sidewalls of the can, even when full of heavy garbage or trash. For additional support, the bag 20 can still be draped over the top edge 16 of the can 5, as a user normally would with any bag 20 known in the art, as seen in FIG. 4. As also seen in FIG. 4, multiple garbage bag retention devices 100 can be applied at different points around the rim of the can or waste receptacle. Devices 100 are shown at areas 401, 403 and 405 and secured to the top edge 16 of the can 5.

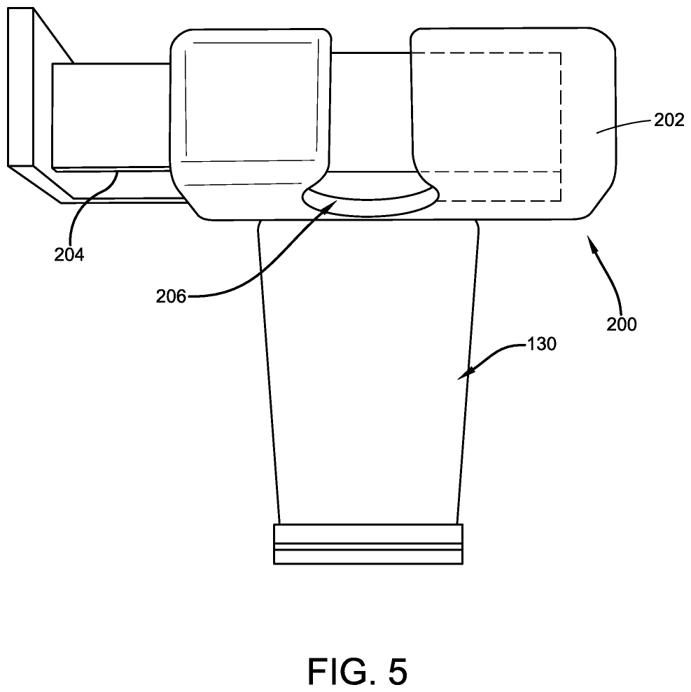

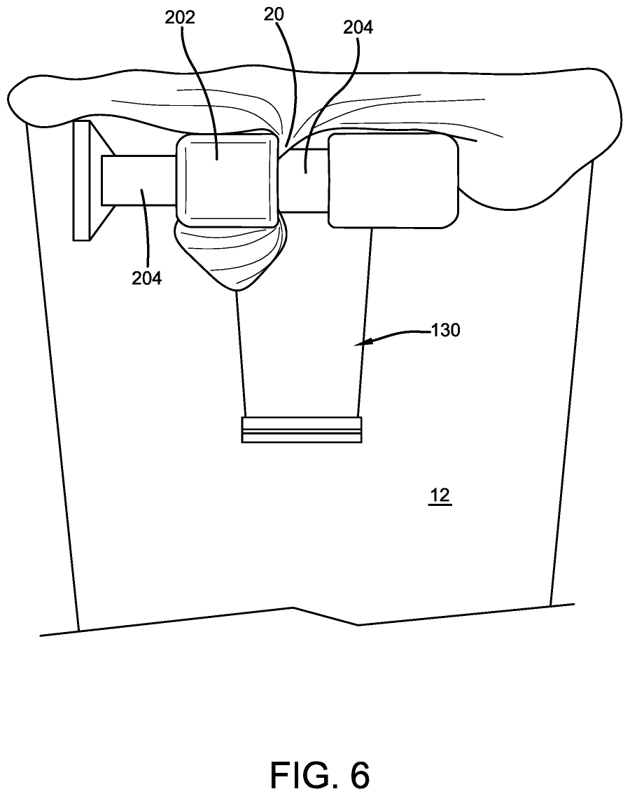

FIG. 5 illustrates a perspective view of one potential embodiment of a garbage bag-retention device 100 of the present invention in accordance with the disclosed structure. In one embodiment, the device 100 may be comprised of an additional retainer clip 200. The clip is preferably fixedly or removably-attached to the outer clip portion 130 and has a generally rectangular body 202. The body 202 receives a spring-loaded plunger member 204 that extends outwards from the body 202 in an unlocked position. In a locked position (as seen in FIG. 6), the plunger 204 can be pressed into the body 202, wherein the plunger 204 is then locked within the body 202 until the plunger 204 is depressed once more. However, before pressing the plunger 204 into the body 202, a garbage bag 20 can be placed in a cutout 206 in the body 202 such that the bag 20 becomes pinned between the body 202 and the plunger 204, when the plunger 204 is locked within the body 202. Therefore, the clip 200 further retains the garbage bag 20 on the device 100. The device is also believed to save on the amount of plastic being used and will therefor help the environment.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “garbage bag-retention device”, “invention”, and “device” are interchangeable and refer to the garbage bag retention device 100 of the present invention.

Notwithstanding the forgoing, the garbage bag retention device 100 of the present invention and its various components can be of any suitable size and configuration as is known in the art without affecting the overall concept of the invention, provided that they accomplish the above-stated objectives. One of ordinary skill in the art will appreciate that the size, configuration and material of the garbage bag retention device 100 as shown in the FIGS. are for illustrative purposes only, and that many other sizes and shapes of the garbage bag retention device 100 are well within the scope of the present disclosure. Although the dimensions of the garbage bag retention device 100 are important design parameters for user convenience, the garbage bag retention device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A garbage bag retention device comprising;
a body having an outer portion, an inner portion and a top portion, wherein the top portion connects the outer portion to the inner portion; and
a tab connected to the inner portion and extending outward and away from the inner portion, wherein the tab comprises a central opening.

2. The garbage bag retention device as recited in claim 1, wherein the tab comprises a plurality of slits.

3. The garbage bag retention device as recited in claim 2, wherein the plurality of slits extend outwardly from the central opening.

4. The garbage bag retention device as recited in claim 3, wherein the plurality of slits extend radially outward from the central opening.

5. The garbage bag retention device as recited in claim 2, wherein the plurality of slits are flexible and deformable.

6. The garbage bag retention device as recited in claim 1, wherein the top portion is comprised of a rounded or bulbous area for fitting around a rim of a garbage can.

7. The garbage bag retention device as recited in claim 1, wherein the tab extends outwardly from a sidewall of a garbage can or waste receptacle in a range of between 0 degrees and 180 degrees.

8. The garbage bag retention device as recited in claim 7, wherein the tab extends outwardly from the sidewall of the garbage can or waste receptacle in a range of between 10 degrees and 45 degrees.

9. The garbage bag retention device as recited in claim 1, wherein the body is comprised or a semi-rigid or flexible material.

10. The garbage bag retention device as recited in claim 1, wherein the body comprises a fastener for holding the body to a sidewall of a garbage can.

11. The garbage bag retention device as recited in claim 10, wherein the fastener is selected from a group consisting of a peelable adhesive layer, a hook and loop fastening assembly, a magnet, a suction cup or a combination thereof.

12. A garbage bag retention device comprising:
an outer wall positioned over an outer surface of a sidewall of a garbage can;
an inner portion adjacent an inner area of the sidewall of the garbage can;
a top portion connecting the outer wall and the inner portion, wherein the top portion comprises a bulbous shape disposed over a rim of the garbage can; and
a tab having a central opening.

13. The garbage bag retention device as recited in claim 12, wherein the tab is provided at an angle in a range between 0 degrees and 180 degrees from the sidewall of the garbage can.

14. The garbage bag retention device as recited in claim 12, wherein the tab is provided at an angle in a range between 10 degrees and 45 degrees from the sidewall of the garbage can.

15. The garbage bag retention device as recited in claim 12, wherein the tab comprises a plurality of slits.

16. The garbage bag retention device as recited in claim 15, wherein the plurality of slits extend radially outward from the central opening.

17. The garbage bag retention device as recited in claim 16, wherein the plurality of slits are flexible and deformable.

18. The garbage bag retention device as recited in claim 12 further comprising a plurality of clips that are positioned around the rim of the garbage can.

19. The garbage bag retention device as recited in claim 12 further comprising at least one of an indica or a chart on one of the outer wall or the inner portion of the clip.

20. A garbage bag retention system comprising:
a garbage can comprising a sidewall and a rim;
a garbage bag; and
at least one clip comprising:
an outer wall;
an inner wall;
a top portion;
a tab extending outwardly from the sidewall of the garbage can, wherein the tab comprises a central opening and a plurality of slits extending radially outwardly from the central opening, and further wherein a portion of the garbage bag is positioned in the central opening.
